(19) United States
(12) Patent Application Publication
(10) Pub. No.: US 2013/0328833 A1
(43) Pub. Date: Dec. 12, 2013

(54) DUAL-MODE INPUT APPARATUS

(71) Applicants: Sheng-Hsien Hsieh, New Taipei City (TW); Shou-Te Wei, New Taipei City (TW); Chia-Te Chou, New Taipei City (TW); You-Xin Liu, New Taipei City (TW); Chun-Chao Chang, New Taipei City (TW)

(72) Inventors: Sheng-Hsien Hsieh, New Taipei City (TW); Shou-Te Wei, New Taipei City (TW); Chia-Te Chou, New Taipei City (TW); You-Xin Liu, New Taipei City (TW); Chun-Chao Chang, New Taipei City (TW)

(21) Appl. No.: 13/553,840

(22) Filed: Jul. 20, 2012

(30) Foreign Application Priority Data
Jun. 6, 2012 (TW) 101120239

(51) Int. Cl. G06F 3/042

(52) U.S. Cl. 345/175

(57) ABSTRACT

A dual-mode input apparatus is disclosed and includes a panel, a processing module, and an image-capturing system capable of capturing images in front of the panel. The image-capturing system can capture a touch input image and a gesture input device by an image-sensing component and a light-modulating component. The processing module processes the sensed images to determine input information. Alternatively, the image-capturing system can include an image-capturing device capable of rotating relative to the panel. The processing module is therefore capable of controlling rotating of the image-capturing device so as to capture a touch input image and a gesture input image selectively for the processing module to determine input information. Therefore, the dual-mode input apparatus of the invention can provide two input modes by use of the same image device, which overcomes the limitation of a conventional single image-capturing system being applied only to a single input architecture.

### BACKGROUND OF THE INVENTION

1. Field of the Invention

The invention relates to an input apparatus, and especially relates to an optical touch input apparatus.

2. Description of the Prior Art

As touch technologies become mature, various touch architectures are widely applied to touch display system, which is different to early input architectures with independent keyboards and mice and improves the convenience of users using electronic apparatus. The size of a current touch screen becomes larger and larger, which can provide users more comfortable conditions of viewing. However, when the user wants to perform touch operation, the user needs to approach the screen, causing that it is inconvenient to the user to view the whole screen during the touch operation, which induces inconvenience in a certain extent to the interaction between the user and the system. Furthermore, it is also inconvenient to the user to perform touch operation over a wide area of the screen. For the inconvenience of the wide-area touch operation, a system of taking gesture images of a user in a space as input is available. Thereby, a user can view the screen at a proper distance and easily perform a wide-area input operation by gestures simultaneously. However, the control preciseness by the gesture input may be insufficient, especially for a small-area input operation such as moving, clicking small icons and so on, leading to poor movement positioning, miss-clicking icons and so on. Either interactive displaying systems of touch input or interactive displaying systems of gesture input have their own physically independent architectures. Therefore, in practice, such interactive displaying system is usually equipped with only an input architecture, so that the interactive displaying system is applicable only to a single input mode, which hardly satisfies both the convenience and the preciseness of input operation.

### SUMMARY OF THE INVENTION

An objective of the invention is to provide a dual-mode input apparatus, which can use an image-capturing device to capture touch images and gesture images in front of a panel thereof for the requirements of touch input and gesture input, which transcends the limitation of a conventional interactive displaying system unable to use a single input architecture to perform two different kinds of input modes.

A dual-mode input apparatus of the invention includes a panel, an image-sensing component, a light-modulating component, and a processing module. A touch input space and a gesture input space are defined in front of the panel. The touch input space is located between the panel and the gesture input space. The light-modulating component is disposed above the image-sensing component toward the touch input space and the gesture input space, such that the image-sensing component is capable of simultaneously sensing a first image relative to the touch input space and a second image relative to the gesture input space through the light-modulating component. The processing module is electrically connected to the image-sensing component and processes at least one of the first image and the second image to determine an input information. In an application, the first image can be a touch image on the panel by a user; the second image can be a gesture image in front of the panel in a distance by the user. Therefore, the dual-mode input apparatus of the invention can allow touch operation and gesture operation by a user to be the basis for input, which transcends the limitation of a conventional interactive displaying system applicable only to a single input mode and further improves the flexibility of interaction input design and satisfies both the convenience and the preciseness of input operation.

Another dual-mode input apparatus of the invention includes a panel, an image-capturing device, and a processing module. A touch input space and a gesture input space are defined in front of the panel. The touch input space is located between the panel and the gesture input space. The image-capturing device is disposed at a circumference of the panel and capable of rotating relative to the panel. The processing module is electrically connected to the image-capturing device and, according to a switching mechanism, controls rotating of the image-capturing device to be capable of selectively capturing either a first image relative to the touch input space or a second image relative to the gesture input space so as to determine an input information. Similarly, the dual-mode input apparatus of the invention can allow touch operation and gesture operation by a user to be the basis for input, which transcends the limitation of a conventional interactive displaying system applicable only to a single input mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating the front-view configuration of a dual-mode input apparatus of an embodiment of the invention.

FIG. 2 is a schematic diagram illustrating a partial side-view configuration of the dual-mode input apparatus in FIG. 1.

FIG. 3 is a schematic diagram illustrating the side view of an image-capturing device according to an embodiment of the invention.

FIG. 4 is a schematic diagram illustrating the side view of an image-capturing device according to an embodiment of the invention.

FIG. 5 is a schematic diagram illustrating the front-view configuration of a dual-mode input apparatus of another embodiment of the invention.

FIG. 6 is a schematic diagram illustrating a partial side-view configuration of the dual-mode input apparatus in FIG. 5.

### DETAILED DESCRIPTION

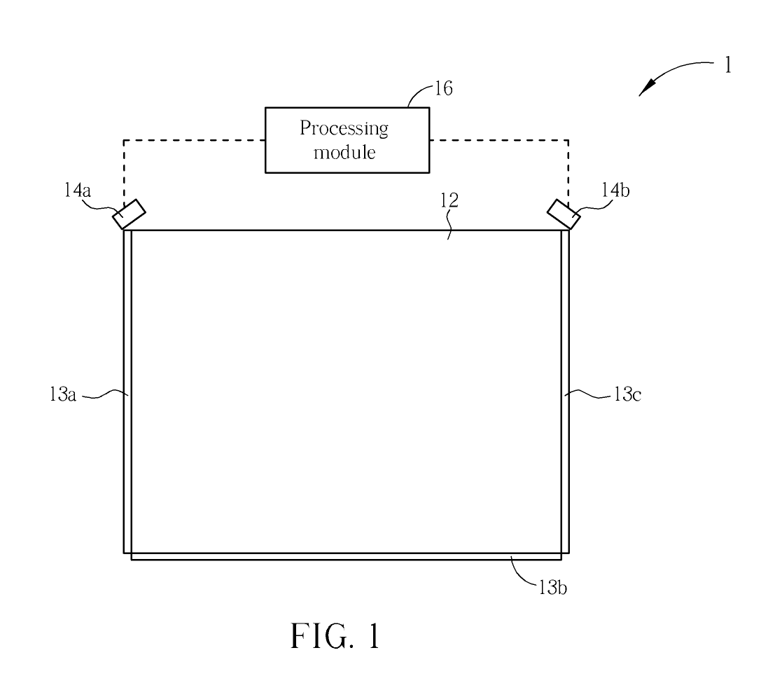

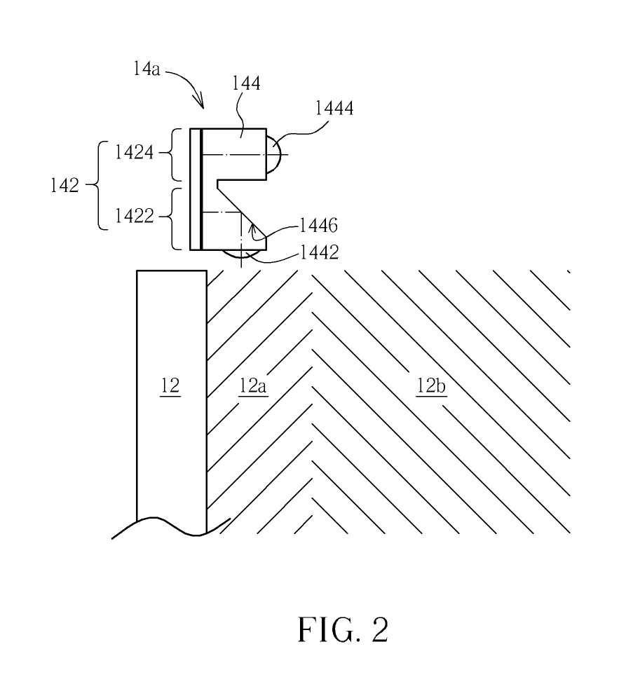

Please refer to FIG. 1 and FIG. 2. FIG. 1 is a schematic diagram illustrating the front-view configuration of a dual-mode input apparatus 1 of an embodiment of the invention. FIG. 2 is a schematic diagram illustrating a partial side-view configuration of the dual-mode input apparatus 1. The dual-mode input apparatus 1 includes a panel 12, two image-capturing devices 14a and 14b, and a processing module 16. The panel 12 is a displaying panel, but the invention is not limited thereto. A touch input space 12a and a gesture input space 12b (shown by dashed lines in FIG. 2) are defined in front of the panel 12. The touch input space 12a is located between the panel 12 and the gesture input space 12b. The image-capturing device 14a and the image-capturing device 14b are identical in structure and symmetrically disposed, and only the image-capturing device 14a will be illustrated in the following. The image-capturing device 14a includes an image-sensing component 142 and a light-modulating component 144. The light-modulating component 144 is disposed above the image-sensing component 142 toward the touch input space 12a and the gesture input space 12b such that the image-sensing component 142 is capable of simultaneously sensing a first image relative to the touch input space 12a and a second image relative to the gesture input space 12b through the light-modulating component 144. The processing module 16 and the image-sensing component 142 are connected electrically (shown by dashed lines). The processing module 16 processes at least one of the first image and the second image to determine an input information, for example movement of an object (such as mouse pointer), object (such as icons) clicking, and other effective trajectories (such as object enlarging, shrinking and rotating).

In the embodiment, when the dual-mode input apparatus 1 is at a touch mode, the processing module 16 will process the first image for the input information. The first image is an image illustrating positions of a finger of a user on the panel 12. An analysis of the position image and a required hardware configuration therefore depend on the used touch technology. In the embodiment, the dual-mode input apparatus 1 uses the two image-capturing devices 14a and 14b and three bar light sources 13a, 13b and 13c (for example light bars for practice), so as to be able to analyze multi-touch positions, but the invention is not limited thereto. It is added that the first image is an image captured from the touch input space 12a, not an image formed by physical touches by the finger on the panel 12; therefore, in practice, an effective capture of the first image is unnecessarily based on a precondition of the finger physically touching the panel 12. In addition, in practice, a single position image can form a touch point position; a sequence of position images can form a trajectory input. These are known by people skilled in the field of optical touch and therefore are not be described herein.

When the dual-mode input apparatus 1 is at a gesture input mode, the processing module 16 will process the second image for the input information. The second image is an image of a finger gesture of the user in the gesture input space 12b. In principle, an image in a space can be captured only by an image-capturing device. In the embodiment, both the image-capturing devices 14a and 14b can capture images relative to the gesture input space 12b. Processing images which are capture simultaneously can also obtain image depth information. However, the invention is not limited thereto. It is added that in the optical touch technology, the first image is usually a one-dimension image. Compared with the first image, the second image is a two-dimension image, which implies more information such as a gesture and a skeleton of a user or a sub-image relative to a specific portion of a user. One two-dimension image can be applicable to various input kinds. A sequence of two-dimension images can also be applicable to input kinds using trajectory.

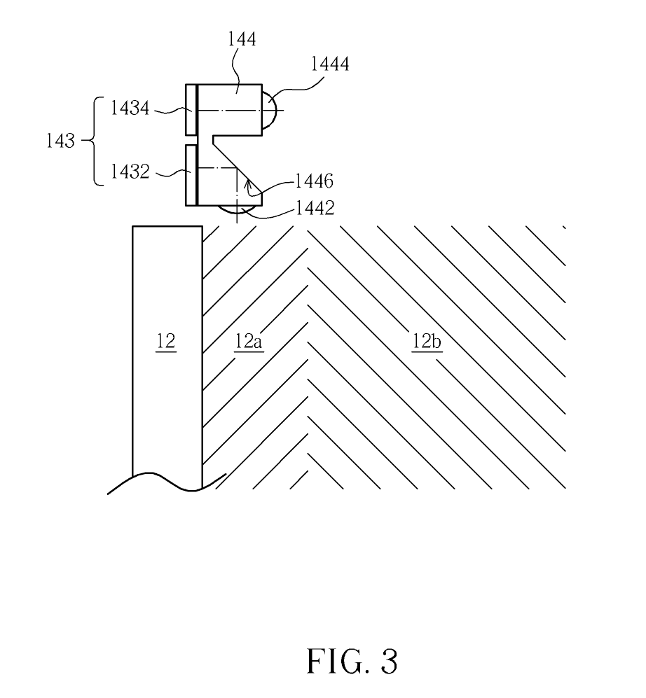

As shown in FIG. 2, the light-modulating component 144 includes a first lens 1442 and a second lens 1444. The image-sensing component 142 includes an optical sensor unit such as CMOS, but the invention is not limited thereto. The optical sensor unit has a first sensing area 1422 and a second sensing area 1424 corresponding to the first lens 1442 and the second lens 1444 respectively. The optical sensor unit uses the first sensing area 1422 to sense the first image relative to the touch input space 12a through the first lens 1442. The optical sensor unit uses the second sensing area 1424 to sense the second image relative to the gesture input space 12b through the second lens 1444. In the embodiment, the optic axis (shown by a chain line in FIG. 2) of the first lens 1442 is parallel to the surface (i.e. touch surface) of the panel 12. The light-modulating component 144 includes a reflection plane 1446 for reflecting light from the first lens 1442 to the first sensing area 1422 of the image-sensing component 142. The second lens 1444 is disposed right opposite to the second sensing area 1424. In practice, a wide-angle lens such as a fish-eye lens can be used as the second lens 1444, so as to be capable of capturing images relative to the gesture input space 12b, but the invention is not limited thereto. For example, in practice, the second lens 1444 can be provided with a reflection plane so as to allow of slant disposition, which is conducive to reduction on the influence of aberration to image analysis. In addition, it is added that in the embodiment, the image-sensing component 142 uses a single optical sensor unit, but the invention is not limited thereto. As shown in FIG. 3, in another embodiment, the image-sensing component 143 uses a first optical sensor unit 1432 and a second optical sensor unit 1434 which are separate and correspond to the first lens 1442 and the second lens 1444 respectively. The first optical sensor unit 1432 senses the first image relative to the touch input space 12a through the first lens 1442. The second optical sensor unit 1434 senses the second image relative to the gesture input space 12b through the second lens 1444.

In the embodiment, the image-sensing component 142 simultaneously senses images at two zones (i.e. the touch input space 12a and the gesture input space 12b), so in practice, the processing module 16 can direct analyze the first image and the second image to determine which mode the dual-mode input apparatus 1 is. For example, if the first image is an ineffective image, the dual-mode input apparatus 1 can be regarded as being in at the gesture input mode, and the processing module 16 processes the second image to determine the input information; if the second image is an ineffective image, the dual-mode input apparatus 1 can be regarded as being at the touch mode, and the processing module 16 processes the first image to determine the input information. Even when the first image and the second image are effective, the dual-mode input apparatus 1 can be regarded as being in a hybrid input mode, and the processing module 16 simultaneously analyzes the first image and the second image to determine the input information, which can increase more available input instances.

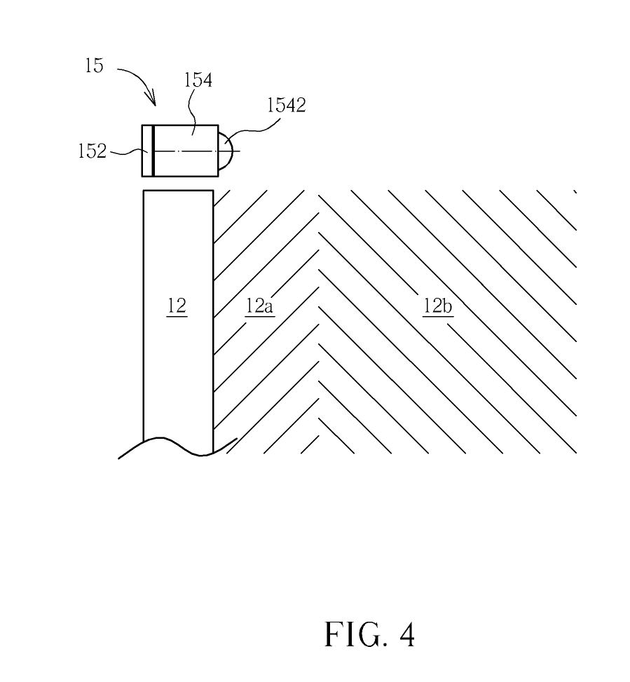

In the above embodiment, the image-capturing device 14a captures images relative to the touch input space 12a and the gesture input space 12b by use of the two lenses 1442 and 1444 respectively, but the invention is not limited thereto. Please refer to FIG. 4, which is a schematic diagram illustrating the side view of an image-capturing device 15 according to another embodiment. The image-capturing device 15 includes an image-sensing component 152 and a light-modulating component 154. The light-modulating component 154 is disposed corresponding to the image-sensing component 152 and includes a fish-eye lens 1542. The image-sensing component 152 can simultaneously sense the first image relative to the touch input space 12a and the second image relative to the gesture input space 12b through the fish-eye lens 1542. Based on optical principle, the areas corresponding to the first image and the second image are distinguishable, so the above explanation of analyzing the images by the image-capturing device 1 to determine the input information is also applicable herein.

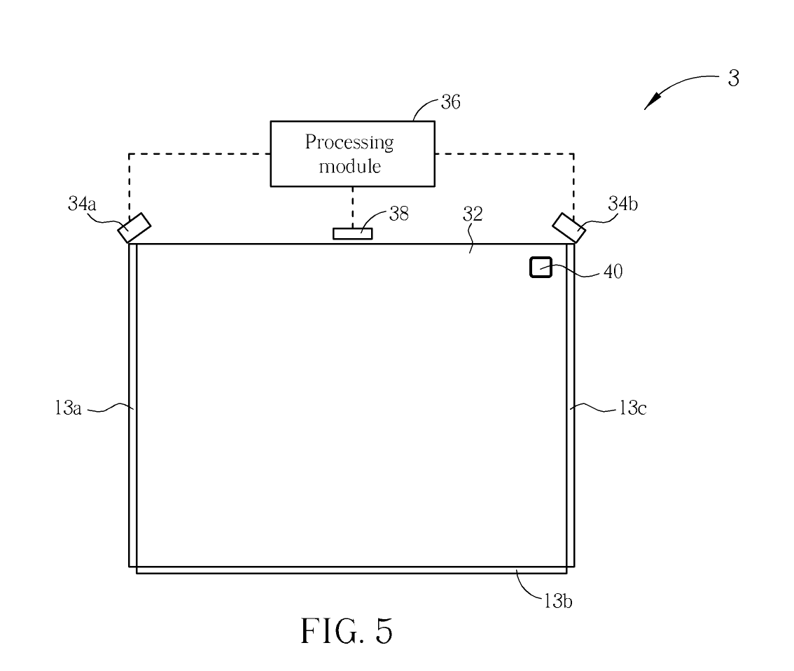

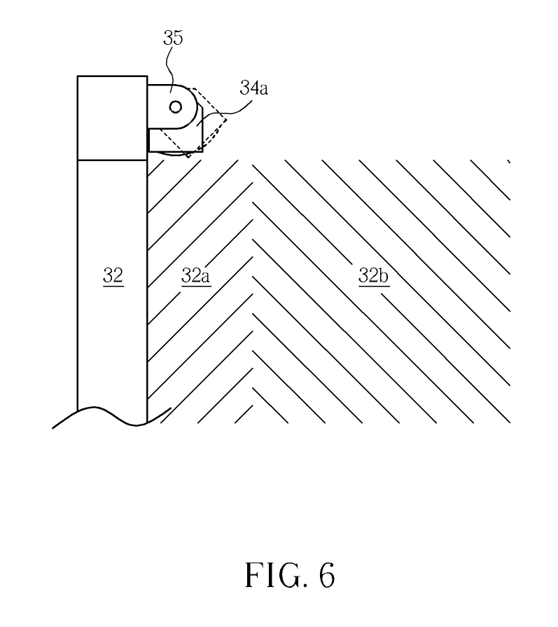

Please refer FIG. 5 and FIG. 6. FIG. 5 is a schematic diagram illustrating the front-view configuration of a dual-mode input apparatus 3 of another embodiment of the invention. FIG. 6 is a schematic diagram illustrating a partial side-view configuration of the dual-mode input apparatus 3. The dual-mode input apparatus 3 includes a panel 32, two image-capturing devices 34a and 34b, and a processing module 36. The panel 32 is a displaying panel, but the invention is not limited thereto. A touch input space 32a and a gesture input space 32b (shown by dashed lines in FIG. 6) are defined in front of the panel 32. The touch input space 32a is located between the panel 32 and the gesture input space 32b. The image-capturing device 34a and the image-capturing device 34b are identical in structure and symmetrically disposed, and only the image-capturing device 34a will be illustrated in the following. The image-capturing device 34a is disposed at a circumference of the panel 32 and capable of rotating relative to the panel 32. In the embodiment, the image-capturing device 34a uses a motor 35 connected thereto so as to rotate relative to the panel 32, but the invention is not limited thereto. The processing module 36 is electrically connected to the image-capturing device 34a and the motor 35. The processing module 36 controls the motor 35 to drive the image-capturing device 34a to rotate such that the image-capturing device 34a is capable of selectively capturing either a first image relative to the touch input space 32a or a second image relative to the gesture input space 32b so as to determine an input information. The configuration of the dual-mode input apparatus 3 is substantially similar in logic to that of the dual-mode input apparatus 1, so please refer to the above relevant description of the dual-mode input apparatus 1 for other description about the dual-mode input apparatus 3, which will not be repeated.

In the embodiment, the image-capturing device 34a can sense images in either the touch input space 32a or the gesture input space 32b at the same time, so in practice, the processing module 36 will switch the input mode of the dual-mode input apparatus 3 according to a switching mechanism. In the embodiment, the dual-mode input apparatus 3 includes a sensor 38 disposed close to the panel 32 (for example at the top middle) and electrically connected to the processing module 36. The sensor 38 is capable of sensing a sensed signal of an object (such as hands or body of a user) in the touch input space 32a or the gesture input space 32b. If the processing module 36 judges that the sensed signal matches a switching criterion, the processing module 36 correspondingly controls the image-capturing device 34a, i.e. controls the motor 35 to rotate such that the image-capturing device 34a is capable of capturing the first image relative to the touch input space 32a or the second image relative to the gesture input space 32b. Thereby, the switching mechanism is realized.

In a practical application, the sensor 38 can be a distance sensor for sensing distance, for example by technologies of infrared ray, radio waves, sonar and so on, so the sensed signal is based on a distance relative to the object. If the processing module 36 judges that the sensed signal is larger than a first predetermined value, the processing module 36 controls the image-capturing device 34a so as to capture the second image relative to the gesture input space 32b. In other words, when the dual-mode input apparatus 3 is at the touch mode, the processing module 36 controls the rotating of the image-capturing device 34a such that the dual-mode input apparatus 3 is at the gesture input mode; when the dual-mode input apparatus 3 is at the gesture input mode, the processing module 36 maintains the current capturing angle of the image-capturing device 34a such that the dual-mode input apparatus 3 keeps being at the gesture input mode.

Similarly, if the processing module 36 judges that the sensed signal is smaller than a second predetermined value (such as 2 cm), the processing module 36 controls the image-capturing device 34a so as to be capable of capturing the first image relative to the touch input space 32a. In other words, when the dual-mode input apparatus 3 is at the gesture input mode, the processing module 36 controls the rotating of the image-capturing device 34a such that the dual-mode input apparatus 3 is at the touch mode; when the dual-mode input apparatus 3 is at the touch mode, the processing module 36 maintains the current capturing angle of the image-capturing device 34a such that the dual-mode input apparatus 3 keeps being at the touch mode. It is added that in practice, the first predetermined value and the second predetermined value can be the same.

In another practical application, the sensor 38 can be a temperature sensor, so the sensed signal is based on a temperature of the object. If the processing module 36 judges that the sensed signal is smaller than a third predetermined value, the processing module 36 controls the image-capturing device 34a to capture the second image relative to the gesture input space 32b. In other words, when the dual-mode input apparatus 3 is at the touch mode, the processing module 36 controls the rotating of the image-capturing device 34a such that the dual-mode input apparatus 3 is at the gesture input mode; when the dual-mode input apparatus 3 is at the gesture input mode, the processing module 36 maintains the current capturing angle of the image-capturing device 34a such that the dual-mode input apparatus 3 keeps being at the gesture input mode.

Similarly, if the processing module 36 judges that the sensed signal is larger than a fourth predetermined value, the processing module 36 controls the image-capturing device 34a so as to be capable of capturing the first image relative to the touch input space 32a. In other words, when the dual-mode input apparatus 3 is at the gesture input mode, the processing module 36 controls the rotating of the image-capturing device 34a such that the dual-mode input apparatus 3 is at the touch mode; when the dual-mode input apparatus 3 is at the touch mode, the processing module 36 maintains the current capturing angle of the image-capturing device 34a such that the dual-mode input apparatus 3 keeps being at the touch mode. It is added that in practice, the third predetermined value and the fourth predetermined value can be the same. Furthermore, in practice, if an environment temperature is also under consideration, the sensor 38 can also sense an environment temperature, and the sensed signal reflects the difference between the sensed temperature relative to the object and the environment temperature.

In the above description, the switching mechanism is triggered by the function of the sensor 38, but the invention is not limited thereto. For example, when the dual-mode input apparatus 3 is at the gesture input mode, the image-capturing device 34a can capture a single input image relative to the gesture input space 32b. The processing module 36 analyzes the content of the single input image. If the processing module 36 judges that the single input image (or the content of this image) matches a foreground ratio requirement or a foreground configuration requirement, the processing module 36 controls the rotating of the image-capturing device 34a such that the image-capturing device 34a is capable of capturing images relative to the touch input space 32a; that is, the dual-mode input apparatus 3 switches from the gesture input mode to the touch mode. Therein, the foreground ratio can be the ratio of the occupied area by a user image in the input image to the whole input image; the foreground configuration can be the configuration situation of the user image in the whole input image, including the skeleton posture of the user. In the embodiment, the switching mechanism is triggered directly by the implicit function of the image-capturing device 34a, which reduces the disposition cost of the sensor 38.

In addition, in the embodiment, the switching mechanism is automatically performed by the dual-mode input apparatus 3, but the invention is not limited thereto. In practice, the switching mechanism can be triggered by an input operation by the user. For example, when the dual-mode input apparatus 3 is at the touch mode, the user can perform touch control operation in the touch input space 32a to the dual-mode input apparatus 3. The image-capturing device 34a correspondingly captures a sequence of input images, each of which includes information of touch positions. The processing module 36 analyzes an input information from the sequence of input images. If the processing module 36 judges that the input information matches a predetermined trajectory or a clicking order, the processing module 36 controls the rotating of the image-capturing device 34a such that the image-capturing device 34a is capable of capturing images relative to the gesture input space 32b; that is, the dual-mode input apparatus 3 switches from the touch mode to the gesture input mode.

In another aspect, when the dual-mode input apparatus 3 is at the gesture input mode, the user can perform gesture input operation in the gesture input space 32b to dual-mode input apparatus 3. The image-capturing device 34a correspondingly captures a sequence of input images. The processing module 36 analyzes an input information from the sequence of input images, for example a movement speed of the skeleton such as arms of the user in the images. If the processing module 36 judges that the input information matches a foreground movement speed requirement, the processing module 36 controls the rotating of the image-capturing device 34a such that the image-capturing device 34a is capable of capturing images relative to the touch input space 32a; that is, the dual-mode input apparatus 3 switches from the gesture input mode to the touch mode. It is added that in practice, the dual-mode input apparatus 3 judges in advance whether the input information is a trigger input for the switching mechanism. If the judgment result is negative, the dual-mode input apparatus 3 treats the input information as a normal input for a feedback to an application program in operation.

In the case of triggering the switching mechanism by the input operation by the user, in practice, the panel 32 thereon (for example on the displaying plane) displays an icon 40 (as shown in FIG. 5) for the user to click for triggering the switching mechanism. That is, if the processing module 36 judges that the icon 40 is clicked, the input mode of the dual-mode input apparatus 3 is switched. The processing module 36 controls the rotating of the image-capturing device 34a such that the image-capturing device 34a is capable of capturing images relative to either the touch input space 32a or the gesture input space 32b correspondingly. In other words, when the user clicks the icon 40, the dual-mode input apparatus 3 switches from the gesture input mode to the touch mode, or from the touch mode to the gesture input mode.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A dual-mode input apparatus, comprising:
a panel, a touch input space and a gesture input space being defined in front of the panel, the touch input space being between the panel and the gesture input space;
an image-sensing component;
a light-modulating component disposed above the image-sensing component toward the touch input space and the gesture input space such that the image-sensing component is capable of simultaneously sensing a first image relative to the touch input space and a second image relative to the gesture input space through the light-modulating component; and
a processing module electrically connected to the image-sensing component, the processing module processing at least one of the first image and the second image to determine an input information.

2. The dual-mode input apparatus of claim 1, wherein the light-modulating component comprises a first lens and a second lens, the image-sensing component senses the first image relative to the touch input space through the first lens, and the image-sensing component senses the second image relative to the gesture input space through the second lens.

3. The dual-mode input apparatus of claim 2, wherein an optic axis of the first lens is parallel to the panel, and the light-modulating component comprises a reflection plane for reflecting light from the first lens to the image-sensing component.

4. The dual-mode input apparatus of claim 2, wherein the image-sensing component comprises a first optical sensor unit and a second optical sensor unit corresponding to the first lens and the second lens respectively, the first optical sensor unit senses the first image relative to the touch input space through the first lens, and the second optical sensor unit senses the second image relative to the gesture input space through the second lens.

5. The dual-mode input apparatus of claim 2, wherein the image-sensing component comprises an optical sensor unit, the optical sensor unit has a first sensing area and a second sensing area corresponding to the first lens and the second lens respectively, the optical sensor unit uses the first sensing area to sense the first image relative to the touch input space through the first lens, and the optical sensor unit uses the second sensing area to sense the second image relative to the gesture input space through the second lens.

6. The dual-mode input apparatus of claim 1, wherein the light-modulating component comprises a fish-eye lens, and the image-sensing component simultaneously senses the first image relative to the touch input space and the second image relative to the gesture input space through the fish-eye lens.

7. The dual-mode input apparatus of claim 1, wherein if the first image is an ineffective image, the processing module processes the second image to determine the input information.

8. The dual-mode input apparatus of claim 1, wherein if the second image is an ineffective image, the processing module processes the first image to determine the input information.

9. The dual-mode input apparatus of claim 1, wherein the panel is a displaying panel.

10. A dual-mode input apparatus, comprising:
a panel, a touch input space and a gesture input space being defined in front of the panel, the touch input space being between the panel and the gesture input space;
an image-capturing device disposed at a circumference of the panel and capable of rotating relative to the panel; and
a processing module electrically connected to the image-capturing device, the processing module, according to a switching mechanism, controlling rotating of the image-capturing device to be capable of selectively capturing either a first image relative to the touch input space or a second image relative to the gesture input space so as to determine an input information.

11. The dual-mode input apparatus of claim 10, further comprising a motor connected to the image-capturing device, wherein the image-capturing device rotates relative to the panel by use of the motor.

12. The dual-mode input apparatus of claim 10, further comprising a sensor disposed close to the panel and electrically connected to the processing module, for sensing a sensed signal of an object in the touch input space or the gesture input space, wherein if the processing module judges that the sensed signal matches a switching criterion, the processing module controls the image-capturing device to capture the first image relative to the touch input space or the second image relative to the gesture input space correspondingly.

13. The dual-mode input apparatus of claim 12, wherein the sensed signal is based on a distance relative to the object, if the processing module judges that the sensed signal is larger than a predetermined value, the processing module controls the image-capturing device to capture the second image relative to the gesture input space.

14. The dual-mode input apparatus of claim 12, wherein the sensed signal is based on a distance relative to the object, if the processing module judges that the sensed signal is smaller than a predetermined value, the processing module controls the image-capturing device to capture the first image relative to the touch input space.

15. The dual-mode input apparatus of claim 12, wherein the sensed signal is based on a temperature relative to the object, if the processing module judges that the sensed signal is smaller than a predetermined value, the processing module controls the image-capturing device to capture the second image relative to the gesture input space.

16. The dual-mode input apparatus of claim 12, wherein the sensed signal is based on a temperature relative to the object, if the processing module judges that the sensed signal is larger than a predetermined value, the processing module controls the image-capturing device to capture the first image relative to the touch input space.

17. The dual-mode input apparatus of claim 10, wherein when the image-capturing device is capable of capturing images relative to the touch input space, the dual-mode input apparatus is at a touch mode, and when the processing module judges that a sequence of input images obtained by the image-capturing device matches a predetermined trajectory or a clicking order, the processing module controls the image-capturing device to rotate so as to be capable of capturing images relative to the gesture input space.

18. The dual-mode input apparatus of claim 10, wherein when the image-capturing device is capable of capturing images relative to the gesture input space, the dual-mode input apparatus is at a gesture input mode, and when the processing module judges that an input image obtained by the image-capturing device matches a foreground ratio requirement or a foreground configuration requirement, the processing module controls the image-capturing device to rotate so as to be capable of capturing images relative to the touch input space.

19. The dual-mode input apparatus of claim 10, wherein when the image-capturing device is capable of capturing images relative to the gesture input space, the dual-mode input apparatus is at a gesture input mode, and when the processing module judges that a sequence of input images obtained by the image-capturing device matches a foreground movement speed requirement, the processing module controls the image-capturing device to rotate so as to be capable of capturing images relative to the touch input space.

20. The dual-mode input apparatus of claim 10, wherein the panel is a displaying panel, the displaying panel displays an icon thereon, and when the processing module judges that the icon is clicked, the processing module controls the image-capturing device to rotate so as to be capable of capturing images relative to the touch input space or the gesture input space.
